(19) United States
(12) Patent Application Publication
(10) Pub. No.: US 2004/0148219 A1
(43) Pub. Date: Jul. 29, 2004

(54) Techniques for conducting a survey using an item selection system

(76) Inventor: John W. Norris III, Columbus, OH (US)

Correspondence Address: BAKER & BOTTS, 30 ROCKEFELLER PLAZA, NEW YORK, NY, 10112

(21) Appl. No.: 10/625,412

(22) Filed: Jul. 23, 2003

Related U.S. Application Data
(60) Provisional application No. 60/397,949, filed on Jul. 24, 2002.

(51) Int. Cl. G06F 17/60; H04H 9/00

(52) U.S. Cl. 705/10; 705/7; 725/14

(57) ABSTRACT

A system for conducting a survey uses an interactive item selection system displayed on a viewing surface of a television. The system includes a database for storing the survey in an electronic format. The survey is associated a product offered by a particular entity to a user of the interactive item selection system and/or a service performed by the particular entity for the user of the interactive item selection system. The system also includes a central web server electrically connected to the database. The central web server is configured receive an electronic request for the survey from the user via a processor when the user selects a particular item of the item selection system. Specifically, the processor is electrically connected to the central web server and the television, and the particular item is associated with the survey. The processor also is located remote from the central web server. The central web server also is configured to transmit the survey to the processor after receiving the electronic request, and the processor is configured to display the survey on the viewing surface after receiving the survey. Moreover, the central web server is configured to receive an electronic response to the survey from the user of the interactive item selection system via the processor.

### CROSS-REFERENCE TO RELATED APPLICATIONS

The present application claims priority from U.S. Provisional Patent Application No. 60/397,949, which was filed on Jul. 24, 2002, and is entitled “Central Survey for Interactive Television Space and Targeting of the Survey and the Results of the Survey to Specific Users,” the disclosure of which is incorporated herein by reference in its entirety.

### FIELD OF THE INVENTION

The present invention relates generally to techniques for conducting a survey using an interactive item selection system, and in particular, to techniques in which a central web server receives an electronic request for the survey from a user of the item selection system, transmits the survey for display on a television which the user is viewing, and receives the user's electronic response to the survey.

### BACKGROUND OF THE INVENTION

Item selection systems are often used in hotel video, on-demand systems to provide a hotel guest with an user-friendly interface for selecting movies and other audio-visual products or services available to the user. In known item selection systems, a first menu is displayed on a television screen. The first menu has several items from which a user of the system makes a selection. For example, a first item of the first menu may correspond to “movies,” and a second item of the first menu may correspond to “games.”

When the user selects the item corresponding to “movies,” a second menu replaces the first menu. The second menu also has several items from which the user can make a selection. For example, a first item of the second menu may correspond to “action movies,” and a second item of the second menu may correspond to “comedy movies.”

When the user selects the item corresponding to “action movies,” a third menu replaces the second menu. The third menu similarly has a several items, each corresponding to a movie which is available for the user to view. When the user selects the item corresponding to a particular movie, the user is prompted to confirm their purchase. After the user confirms their purchase, the user can watch the particular movie on the television.

Moreover, hotels often conduct surveys to gain insight into attitudes which their guests have toward the hotel and services performed by the hotel. For example, such surveys may be conducted by mailing a survey to the hotel guest at their residence, conducting a telephone or an in-person interview with the hotel guest, requesting that the hotel guest respond to printed surveys located in their hotel room, or via the Internet.

Unfortunately, these hotel surveys are often expensive and ineffective. Specifically, printed surveys are expensive and it is difficult to alter the survey. Mailing the survey to the hotel guest is expensive and suffers from low participation rates. Telephone and in-person surveys are intrusive to the hotel guest and require substantial manpower. Moreover, Internet surveys are limited to those that have access to a computer system. Therefore, a need has arisen for techniques for conducting a survey which overcomes these and other shortcomings of the related art.

### SUMMARY OF THE INVENTION

An object of the present invention is to provide a technique which enables several hotel or hotel management companies, to conduct surveys using an interactive item selection system, which is inexpensive, effective, and non-intrusive to the hotel guest.

Another object of the present invention is to link the item selection system to the survey.

In order to meet these objectives and others that will become apparent with reference to the disclosure below, the present invention provides techniques for conducting surveys, in which a provider of the item selection system receives or generates a survey for one or more hotels. For example, the provider may receive the survey from each hotel, or may generate a survey for each hotel. The survey may be unique for each hotel, or the same survey may be used for each hotel. The survey may be associated with products offered by the hotels to their guests and/or services performed by the hotels for their guests. The provider then may store the surveys in an electronic database.

During their stay at a particular hotel, the hotel guest may use the item selection system displayed on a viewing surface of a television in their room to watch movies, access the Internet, and/or review services offered by the particular hotel. The hotel guest also may use the item selection system to respond to the survey associated with the particular hotel.

Specifically, a particular item of the interactive item selection system is displayed on the viewing surface of the television, and the particular item is associated with the particular hotel's survey. For example, the particular item may be the phrase “Hotel Guest Survey.” When the hotel guest selects the particular item, a processor associated with the television may transmit an electronic request for the survey to a central web server of the provider. The processor is located remote from the central web server, such that the central web server may receive electronic requests from different hotels. The central web server then may obtain the survey from the database, and transmit the survey to the processor. For example, the survey may be transmitted in a Hypertext Mark-up Language (“HTML”) format. The processor then may display the survey or a portion of the survey on the viewing surface of the television.

The hotel guest then may electronically respond to the survey using the interactive item selection system. For example the hotel guest may input their answers to survey questions using a remote control for the television, and then may transmit their answers to the central web server, such that the answers may be stored in a database. The answers may be transmitted after the hotel guest completes the entire survey, or may be transmitted after each survey question answered by the hotel guest.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a schematic diagram of a system for conducting a survey using an interactive item selection system displayed on a viewing surface of a television, according to an embodiment of the present invention.

FIG. 2 is a schematic diagram of the interactive item selection system of FIG. 1.

FIG. 3 is a flow-chart of a method for conducting a survey using an interactive item selection system displayed on a viewing surface of a television, according to an embodiment of the present invention.

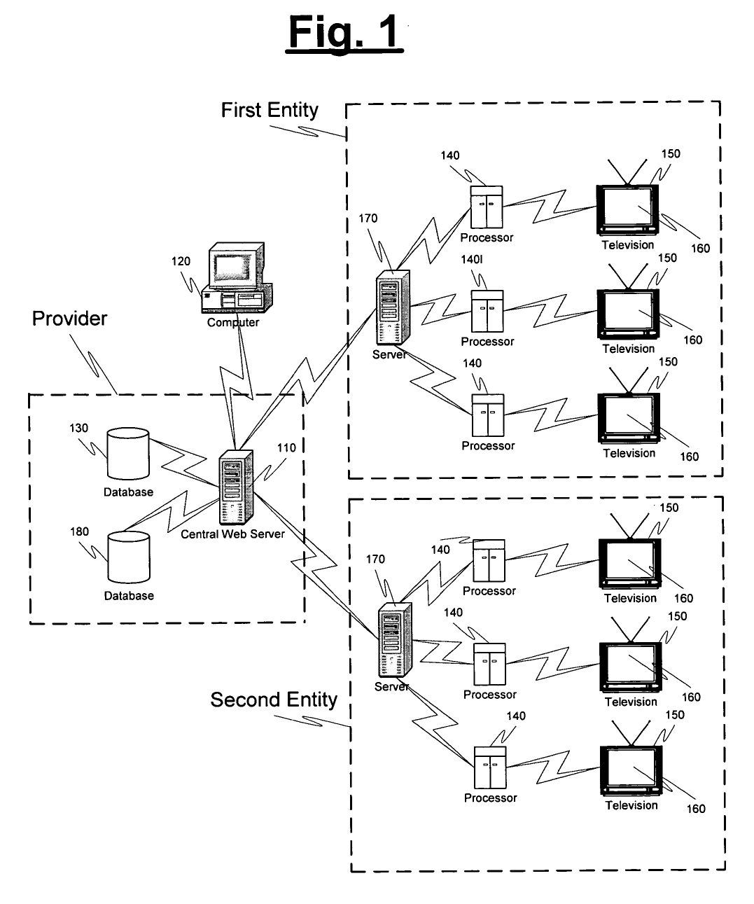

In FIGS. 1-3, like numerals are used for like corresponding parts in the various drawings.

### DETAILED DESCRIPTION OF PRESENTLY PREFERRED EMBODIMENTS

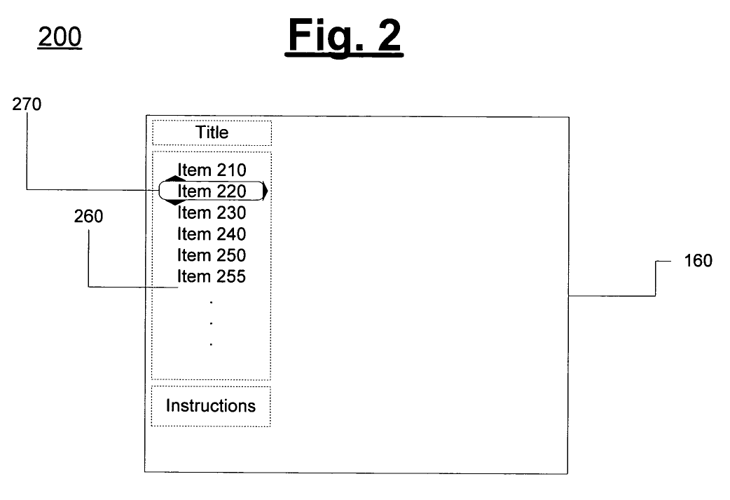

FIG. 2 depicts an interactive item selection system 200 according to an embodiment of the present invention. For example, item selection system 200 may be used in hotel video on-demand systems to provide a hotel guest with an user-friendly interface for selecting movies and other audio-visual products or services available to the user. Item selection system 200 may be displayed on a viewing surface 160 of a television 150.

In an embodiment of the present invention, item selection system 200 may include a first menu 260, and first menu 260 may include several items, such as items 210-250. For example, item 210 may correspond to “Internet,” item 220 may correspond to “games,” item 230 may correspond to “movies,” item 240 may correspond to “local information,” and item 250 may correspond to “hotel information and/or products and/or services.” In the present invention, first menu 260 also includes a particular item 255, which is associated with a hotel guest survey. For example, particular item 255 may be the phrase “Hotel Guest Survey.” The survey may be associated with products offered by the hotel to their guests and/or services performed by the hotel for their guests.

First menu 260 also may include a cursor 270, such as a hotspot indicator, for selecting one of the items in first menu 260. In the present invention, a cursor is defined as any indicator, such as a visual indicator, showing or otherwise indicating the user's current location or position within item selection system 200.

In an embodiment of the present invention, item selection system 200 also may include a second menu (not shown). For example, the second menu may be positioned adjacent to first menu 260, such that first menu 260 and the second menu are displayed simultaneously. Alternatively, the second menu may not be viewable until cursor 270 selects the focus item of first menu 260. The second menu may include at least one item associated with one of the items in first menu 260.

Specifically, cursor 270 may be positioned adjacent to or may surround a particular one of the items in first menu 260, and the items listed in the second menu may be associated with this particular item. The item which cursor 270 is positioned adjacent to or surrounds is hereinafter referred to as the “focus item.” In this embodiment, when the user of item selection system 200 selects the focus item, the second menu may replace first menu 260, and first menu 260 may be removed from viewing surface 160 of television 150.

FIG. 1 depicts a system 100 for conducting a survey using item selection system 200, according to an embodiment of the present invention. System 100 may include a central web server 110 operated by the provider of item selection system 200, and a computer system 120 electrically connected to central web server 110. Computer system 120 may be a computer system of the provider of item selection system 200, or may be a computer system of an entity for whom the provider is conducting the survey, depending on whether the provider or the entity generates the survey.

Specifically, when the provider generates the survey, computer system 120 may be the provider's computer system, and when the entity generates the survey, computer system 120 may be the entity's computer system. The entity can be a hotel, a motel, or the like. It should be understood that the term entity as used herein may include the hotel and/or a management company of the hotel.

Moreover, central web server 110 may include a first database 130 for storing the survey. Specifically, the survey may be transmitted from computer system 120 to first database 130, and first database 130 may store the survey. Alternatively, first database 130 may be remote from central web server 110. In this embodiment, the survey may be transmitted from computer system 120 to central web server 110, and then may be transmitted from central web server 110 to first database 130.

System 100 also may include a server 170 of the entity, processors 140 of the entity, and one or more televisions 150 of the entity. Specifically, server 170 may be electrically connected to central web server 110, and processors 140 may be electrically connected to server 170 and a corresponding one of televisions 160. Each processor 140 may be located proximate to server 170, or may be located proximate to the corresponding one of televisions 150. As such, each processor 140 is located remote from central web server 110. Further, because processors 140 are located remote from central web server 110, central web server 110 may be configured to communicate with processors 140 which are associated with separate entities. It should be understood that the term separate entities may include entities which are not associated with each other and/or entities which are in different locations.

During their stay at the hotel, the hotel guest may use item selection system 200 displayed on viewing surface 160 of television 150 in their room to watch movies, access the Internet, and/or review services offered by the hotel. The hotel guest also may use item selection system 200 to respond to the survey.

Specifically, as described above, particular item 255 is displayed on viewing surface 160 of television 150, and particular item 255 is associated with the survey. When the hotel guest selects particular item 255, processor 140 may transmit an electronic request for the survey to central web server 110. Central web server then may obtain the survey from first database 130, and transmit the survey to processor 140. For example, the survey may be transmitted in a Hypertext Mark-up Language (“HTML”) format. Processor 140 then may display the survey or a portion of the survey on viewing surface 160 of television 150. It should be understood that communication between central web server 110 and processors 140 may be via server 170 or may be independent from server 170. Moreover, communication between central web server 110 and processors 140 may be via the Internet, an intranet, a network of computers, or the like.

The hotel guest then may electronically respond to the survey using interactive item selection system 200. For example the hotel guest may input their answers to survey questions using a remote control for television 150, and then may transmit their answers to central web server 110 via processor 140, such that the answers may be stored in a second database 180. Second database 180 may be the same database as first database 130, or may be a different database. Second database 180 also may be remote from central web server 110, or central web server 110 may include second database 180. Moreover, the answers may be transmitted after the hotel guest completes the entire survey, or may be transmitted after each survey question answered by the hotel guest. The answers then may be compiled and/or formatted for presentation of data associated with the survey answers.

In another embodiment of the present invention, when one or more of the hotel guest's answers match a predetermined answer, the provider may notify a representative of the entity that one of their hotel guests responded to the survey and provided the predetermined answer. For example, when one or more of the hotel guest's answers indicate that they were not satisfied by a service which the hotel provided, the provider may notify the representative of the hotel, such as by sending an e-mail. Such notification may be done in real time, such that the representative may take appropriate action before the hotel guest checks out of the hotel. For example, if the hotel guest's answer indicates that the hotel guest ordered room service, but was not satisfied with the hotel's service, the representative may offer the hotel guest a complimentary meal from the room service menu.

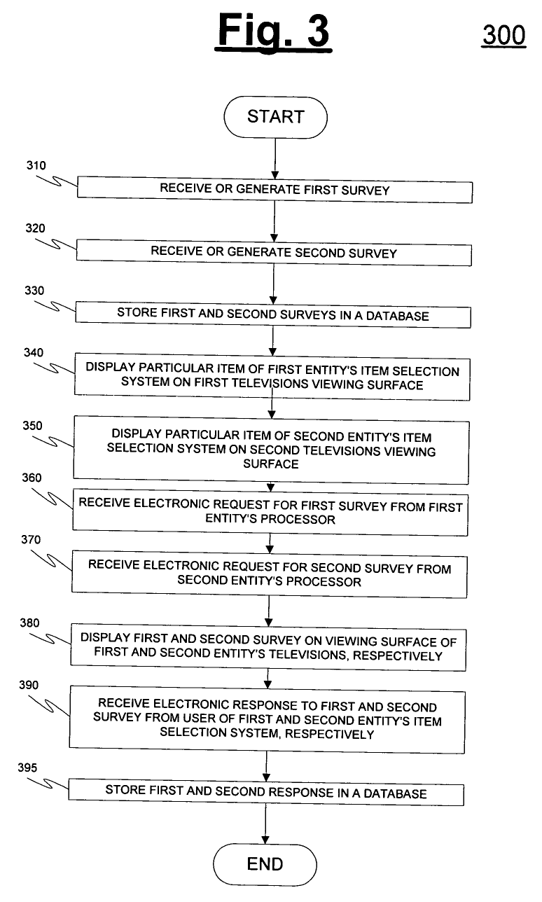

FIG. 3 depicts a method 300 for conducting surveys using interactive item selection system 200, according to an embodiment of the present invention. Method 300 may be implemented by software residing on system 100. In step 310, central web server 110 may receive or generate a first survey. The first survey is associated products offered by a first entity to a user of the first entity's interactive item selection system 200 and/or services performed by the first entity for their user. In step 320, central web server 110 may receive or generate a second survey. The second survey is associated products offered by a second entity to a user of the second entity's interactive item selection system 200 and/or services performed by the second entity for their user.

For example, the first entity may be a first hotel and the user of the first entity's interactive item selection system may be a guest or an employee of the first hotel. Similarly, the second entity may be a second hotel and the user of the second entity's interactive item selection system may be a guest or an employee of the second hotel. Moreover, the first entity and the second entity may have their own interactive item selection system 200, and the first entity's interactive item selection system 200 may include substantially the same items as the second entity's interactive item selection system 200. Alternatively, each item selection system 200 may be tailored to the particular products and/or services offered by the first entity and the second entity, respectively, such that each item selection system 200 may include different items.

In step 330, the first survey and the second survey may be stored in a database, such as database 130. In step 340, one of the first entity's processors 140 may display a particular item of the first entity's interactive item selection system 200 on viewing surface 160 of the first entity's television 150. Specifically, the particular item of the first entity's interactive item selection system 200 is associated with the first survey. In step 350, one of the second entity's processors 140 may display a particular item of the second entity's interactive item selection system 200 on viewing surface 160 of the second entity's television 150. Specifically, the particular item of the second entity's interactive item selection system 200 is associated with the second survey.

In step 360, central web server 110 receives an electronic request from the first entity's processor 140 for the first survey when the user of the first entity's interactive item selection system 200 selects the particular item of the first entity's interactive item selection system. Similarly, in step 370, central web server 110 receives an electronic request from the second entity's processor 140 for the second survey when the user of the second entity's interactive item selection system 200 selects the particular item of the second entity's interactive item selection system.

In step 380, the first entity's processor 140 may display the first survey (or a portion thereof) on viewing surface 160 of the first entity's television 150, and the second entity's processor 140 may display the second survey (or a portion thereof) on viewing surface 160 of the second entity's television 150. In step 390, central web server 110 receives an electronic response to the first survey and the second survey from the user of the first entity's interactive item selection system 200 and the second entity's interactive item selection system 200, respectively. Moreover, in step 395, the response to the first survey and the response to the second survey are stored in a database, such as database 130 or 180.

While the invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for conducting a first survey using a first interactive item selection system displayed on a viewing surface of a first television, and for conducting a second survey using a second interactive item selection system displayed on a viewing surface of a second television, comprising the steps of:
receiving or generating the first survey, wherein the first survey is associated with at least one of a product offered by a first entity to a user of the first interactive item selection system and a service performed by the first entity for the user of the first interactive item selection system;
receiving or generating the second survey, wherein the second survey is associated with at least one of a product offered by a second entity to a user of the second interactive item selection system and a service performed by the second entity for the user of the second interactive item selection system, wherein the first entity and the second entity are separate entities;
storing the first survey and the second survey;
displaying a particular item of the first interactive item selection system on the viewing surface of the first television, wherein the particular item is associated with the first survey;
displaying a further item of the second interactive item selection system on the viewing surface of the second television, wherein the further item is associated with the second survey;
receiving an electronic request for the first survey when the user of the first interactive item selection system selects the particular item;
receiving an electronic request for the second survey when the user of the second interactive item selection system selects the further item;
displaying at least one portion of the first survey on the viewing surface of the first television after receiving the electronic request for the first survey;
displaying at least one portion of the second survey on the viewing surface of the second television after receiving the electronic request for the second survey;
receiving an electronic response to the first survey from the user of the first interactive item selection system;
receiving an electronic response to the second survey from the user of the second interactive item selection system; and
storing the response to the first survey and the response to the second survey in a particular database.

2. The method of claim 1, wherein the step of receiving or generating the first survey includes the step of receiving the first survey from a first hotel or generating the first survey for the first hotel, and wherein the step of receiving or generating the second survey includes the step of receiving the second survey from a second hotel or generating the second survey for the second hotel.

3. The method of claim 1, wherein the step of displaying the at least one portion of the first survey on the viewing surface of the first television includes the step of transmitting the first survey from a central web server to a first processor, wherein the first processor is coupled to the central web server and the first television.

4. The method of claim 3, wherein the step of displaying the at least one portion of the second survey on the viewing surface of the second television includes the step of transmitting the second survey from the central web server to a second processor, wherein the second processor is coupled to the central web server and the second television.

5. The method of claim 4, wherein the step of transmitting the first survey from the central web server to the first processor includes the step of transmitting the first survey in a Hypertext Mark-up Language format, and wherein the step of transmitting the second survey from the central web server to the second processor includes the step of transmitting the second survey in the Hypertext Mark-up Language format.

6. The method of claim 1, wherein the step of receiving the electronic response to the first survey includes the step of transmitting a particular message to a representative of the first entity when at least one portion of the electronic response to the first survey corresponds to a particular predetermined response.

7. The method of claim 6, wherein the step of receiving the electronic response to the second survey includes the step of transmitting a further message to a representative of the second entity when at least one portion of the electronic response to the second survey corresponds to a further predetermined response.

8. The method of claim 4, wherein the first survey and the second survey are stored in a further database, the central web server includes the first database, and the second database is located remote from the central web server and the processor.

9. The method of claim 1, wherein the first survey includes a first plurality of questions and the second survey includes a second plurality of questions, wherein the first plurality of questions and the second plurality of questions are substantially the same questions.

10. A system for conducting a survey using an interactive item selection system displayed on a viewing surface of a television, comprising:
means for storing the survey in an electronic format, wherein the survey is associated with at least one of a product offered by a particular entity to a user of the interactive item selection system and a service performed by the particular entity for the user of the interactive item selection system; and
a central web server coupled to the means for storing and configured to:
receive an electronic request for the survey from the user via a processor when the user selects a particular item of the item selection system, wherein the processor is coupled to the central web server and the television, the processor is located remote from the central web server, and the particular item is associated with the survey.
transmit the survey to the processor after receiving the electronic request, wherein the processor is configured to display at least one portion of the survey on the viewing surface of the television after receiving the survey; and
receive an electronic response to the survey from the user of the interactive item selection system via the processor.

11. The system of claim 10, further comprising means for storing the electronic response in the electronic format.

12. The system of claim 10, wherein the particular entity is a hotel, and the user is one of a guest of the hotel and an employee of the hotel.

13. The system of claim 10, further comprising:
at least one server, wherein the at least one server is coupled to the central web server and the processor, such that the central web server is coupled to the processor via the at least one server.

14. The system of claim 10, wherein the processor is located remote from the television.

15. The system of claim 10, wherein the central web server is configured to transmit the survey to the processor in a Hypertext Mark-up Language format.

16. The system of claim 10, further comprising means for transmitting a particular message to a representative of the particular entity when at least one portion of the electronic response to the survey corresponds to a predetermined response.

17. A system for conducting a first survey using a first interactive item selection system displayed on a viewing surface of a first television, and for conducting a second survey using a second interactive item selection system displayed on a viewing surface of a second television, comprising:
means for storing the first survey and the second survey in an electronic format, wherein the first survey is associated with at least one of a product offered by a first entity to a user of the first interactive item selection system and a service performed by the first entity for the user of the first interactive item selection system, wherein the second survey is associated with at least one of a product offered by a second entity to a user of the second interactive item selection system and a service performed by the second entity for the user of the second interactive item selection system, and wherein the first entity and the second entity are separate entities; and
a central web server coupled to the means for storing and configured to:
receive an electronic request for the first survey from the user of the first interactive item selection system via a first processor when the user selects a particular item of the first item selection system, wherein the first processor is coupled to the central web server and the first television, the particular item is associated with the first survey, and the first processor is located remote from the central web server;
receive an electronic request for the second survey from the user of the second interactive item selection system via a second processor when the user selects a further item of the second item selection system, wherein the second processor is coupled to the central web server and the second television, the further item is associated with the second survey, and the second processor is located remote from the central web server and the first processor;
transmit the first survey to the first processor after receiving the electronic request for the first survey, wherein the first processor is configured to display at least one portion of the first survey on the viewing surface of the first television;
transmit the second survey to the second processor after receiving the electronic request for the second survey, wherein the second processor is configured to display at least one portion of the second survey on the viewing surface of the second television;
receive an electronic response to the first survey from the user of the first interactive item selection system via the first processor; and
receive an electronic response to the second survey from the user of the second interactive item selection system via the second processor.
